(19) United States
(12) Patent Application Publication
(10) Pub. No.: US 2003/0086638 A1
(43) Pub. Date: May 8, 2003

(54) Optical all-pass filter with gain compensation

(75) Inventors: Sergey Frolov, Berkeley Heights, NJ (US); Joseph Shmulovich, New Providence, NJ (US); Tek-Ming Shen, Westfield, NJ (US)

Correspondence Address: MAYER, FORTKORT & WILLIAMS, PC, 251 NORTH AVENUE WEST, 2ND FLOOR, WESTFIELD, NJ, 07090, US

(73) Assignee: Inplane Photonics, Inc.

(21) Appl. No.: 10/003,700

(22) Filed: Nov. 2, 2001

(51) Int. Cl. G02B 6/35; G02B 6/26

(52) U.S. Cl. 385/17; 385/15; 385/39

(57) ABSTRACT

In accordance with the present invention, an optical device is provided that includes an N×N network, where N is an integer greater than or equal to 2. The network has N input ports for receiving optical input energy and N output ports for providing optical output energy. The optical output energy at each of the output ports arises from interference among the optical input energy received at the input ports. (N−1) feedback paths optically couple (N−1) of the input ports of the N×N network to (N−1) of the output ports of the N×N network. A first optical waveguide, which is provided for receiving an input optical signal, is coupled to a remaining one of the input ports of the N×N network. A second optical waveguide, which is provided for the exit of an output optical signal, is coupled to a remaining one of the output ports of the N×N network. Finally, an active element is provided which selectively supplies gain or loss to optical energy in at least one of the feedback paths. The optical device may be employed as a dispersion compensator or an amplifier.

### FIELD OF THE INVENTION

The present invention relates generally to optical all-pass filters, and more particularly to optical all-pass filters that can be used to provide dispersion and gain compensation on optical communication systems.

### BACKGROUND OF THE INVENTION

Optical wavelength division multiplexing (WDM) has gradually become the standard backbone networks for fiber optic communication systems. WDM systems employ signals consisting of a number of different wavelength optical signals, known as carrier signals or channels, to transmit information on optical fibers. Each carrier signal is modulated by one or more information signals. As a result, a significant number of information signals may be transmitted over a single optical fiber using WDM technology.

One phenomenon that has an adverse effect on the quality of a WDM optical signal is chromatic dispersion, in which the index of refraction of the transmission medium is dependent on wavelength. Chromatic dispersion causes the different wavelengths of a signal to undergo different phase shifts, resulting in spreading or broadening of the signal, which can give rise to transmission errors. The term chromatic dispersion, or simply dispersion, as used in this disclosure refers to the first and higher order derivatives of the group delay that are applied to an optical signal. The term group delay refers to the slope of the phase response with respect to frequency.

Dispersion compensating elements are available that apply a second dispersion to the optical signal, which is the negative of the dispersion that was caused by the dispersive device. The second dispersion is additive with the dispersion applied by the dispersive device, so the net dispersion of the optical signal is about zero. Dispersion compensating fibers and chirped fiber Bragg gratings are examples of fiber dispersion compensating elements. However, dispersion compensating fibers are lossy (about 5-10 dB). Lossy fibers are undesirable because they potentially reduce the optical power of signals transmitted along their length. Many chirped fiber Bragg gratings typically only compensate for quadratic dispersion, limiting their utility to systems with quadratic dispersion. Also, chirped fiber Bragg gratings require a circulator for separating dispersion compensated optical signals from non-compensated optical signals. Additionally, chirped fiber Bragg gratings are long devices, making them expensive to integrate into optical communication systems.

Since dispersion is characterized by a frequency dependent phase shift, another way of viewing dispersion is as a mechanism that causes phase distortion. From this viewpoint a dispersion compensating element may be thought of as a phase equalizer. Ideally, a phase equalizer should only affect the phase of the signal without imparting any amplitude distortion. Such a device is known as a phase-only filter or an all-pass filter (APF). An example of an all-pass filter that can be employed as a dispersion compensator is shown in U.S. Pat. No. 6,289,151. One advantage of all-pass filters in comparison to other dispersion compensation techniques is that APF's may, in principle, correct any order dispersion. However, the APF shown in the aforementioned patent does not take into account the various optical losses that inherently arise in the device.

### SUMMARY OF THE INVENTION

In accordance with the present invention, an optical device is provided that includes an N×N network, where N is an integer greater than or equal to 2. The network has N input ports for receiving optical input energy and N output ports for providing optical output energy. The optical output energy at each of the output ports arises from interference among the optical input energy received at the input ports. (N−1) feedback paths optically couple (N−1) of the input ports of the N×N network to (N−1) of the output ports of the N×N network. A first optical waveguide, which is provided for receiving an input optical signal, is coupled to a remaining one of the input ports of the N×N network. A second optical waveguide, which is provided for the exit of an output optical signal, is coupled to a remaining one of the output ports of the N×N network. Finally, an active element is provided which selectively supplies gain or loss to optical energy in at least one of the feedback paths.

In accordance with one aspect of the invention, the N×N network may be a 2×2 network such as a directional coupler or a Mach-Zehnder interferometer.

In accordance with another aspect of the invention, the active element is an optical amplifier such as a rare-earth doped optical amplifer.

In accordance with yet another aspect of the invention, a method is provided for reducing the dispersion of an optical signal. The method begins by directing the optical signal to an input waveguide of an optical device. The input waveguide is coupled to a first input port of an N×N network, where N is an integer greater than or equal to 2. The network has N input ports for receiving optical input energy and N output ports for providing optical output energy, wherein the optical output energy at each of the output ports arises from interference among the optical input energy received at the input ports. The optical device also includes (N−1) feedback paths optically coupling (N−1) of the input ports of the N×N network to (N−1) of the output ports of the N×N network. A remaining one of the output ports of the N×N network provides a dispersion compensated optical output signal. The method continues by selectively supplying gain or loss to optical energy in at least one of the feedback paths to reduce to a selected value the dispersion of the dispersion compensated optical output signal.

In accordance with another aspect of the invention, a method of amplifying an optical signal is provided. The method begins by directing the optical signal to an input waveguide of an optical device. The input waveguide is coupled to a first input port of an N×N network, where N is an integer greater than or equal to 2. The network has N input ports for receiving optical input energy and N output ports for providing optical output energy, wherein the optical output energy at each of the output ports arises from interference among the optical input energy received at the input ports. The optical device further includes (N−1) feedback paths optically coupling (N−1) of the input ports of the N×N network to (N−1) of the output ports of the N×N network. A remaining one of the output ports of the N×N network provides an optical output signal. The method continues by selectively tuning a coupling coefficient between the first input port and the remaining one of the output ports to adjust to a selected value the gain or loss imparted to the optical output signal.

### BACKGROUND OF THE INVENTION

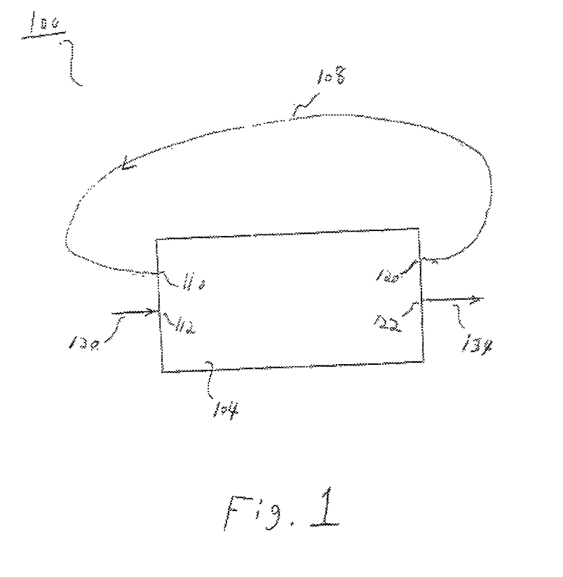

FIG. 1 shows a schematic diagram of a simplified all-pass optical filter (APF).

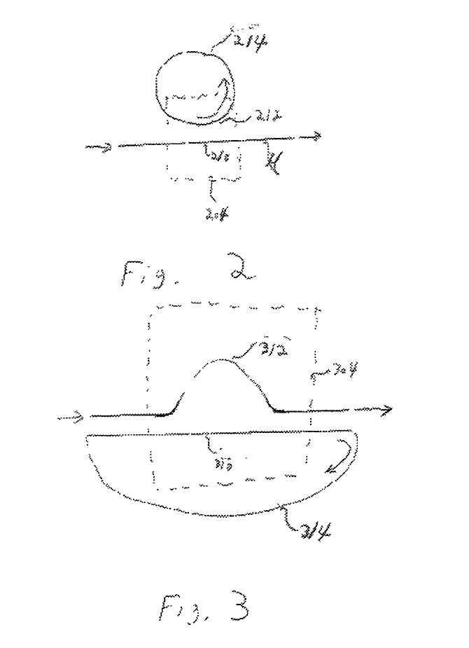

FIG. 2 shows an all-pass optical filter formed from a directional coupler.

FIG. 3 shows an all-pass optical filter formed from a Mach-Zehnder interferometer.

FIG. 4 shows a graph of the group delay (in arbitrary units) of an APF versus wavelength for different values of gain imparted by the APF.

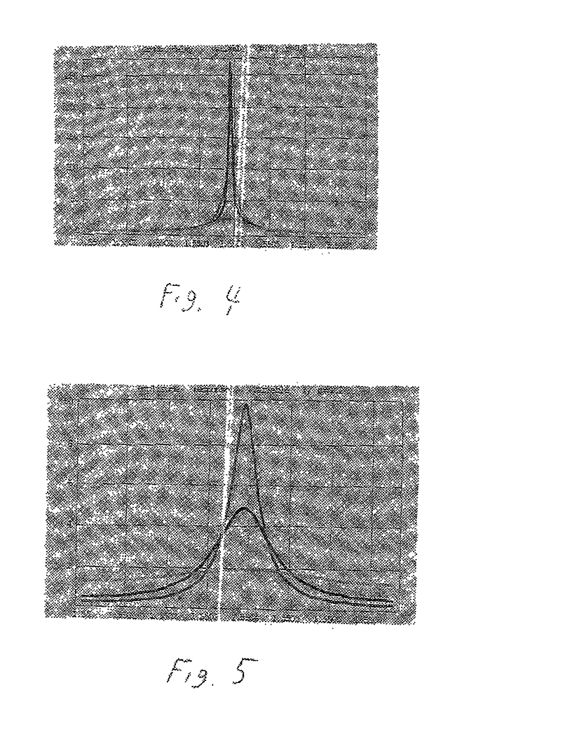

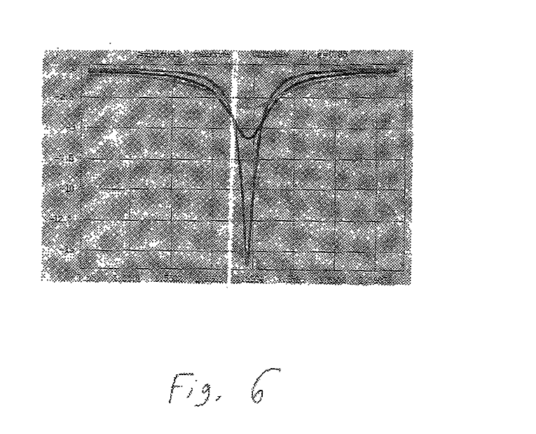

FIG. 5 shows a graph of the amplitude response (in arbitrary units) of an APF with a fixed gain coefficient and different coupling coefficients.

FIG. 6 shows a graph of the amplitude response (in arbitrary units) of a conventional APF that imparts optical loss for three different coupling coefficients.

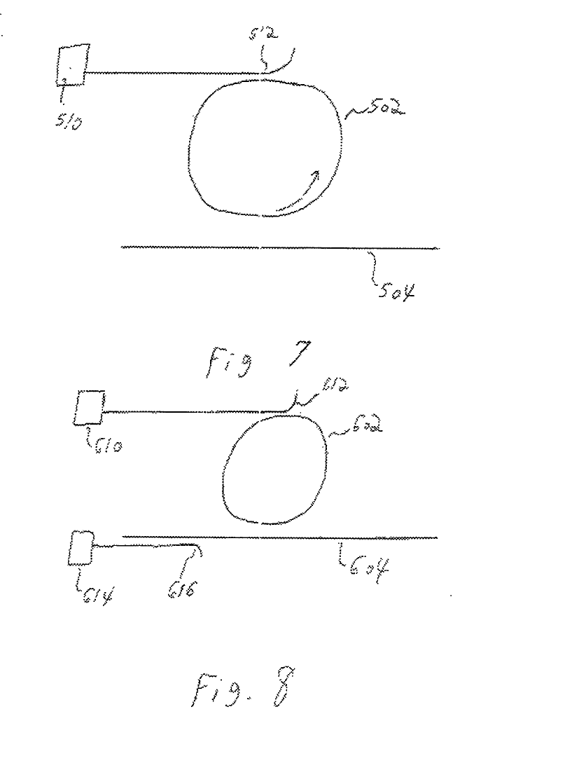

FIG. 7 shows one embodiment of an APF constructed in accordance with the present invention.

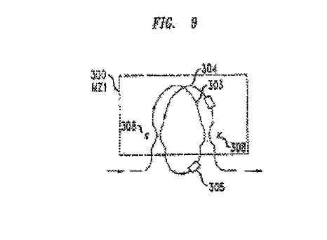

FIG. 8 shows an alternative embodiment of an APF constructed in accordance with the present invention.

FIG. 9 shows an all-pass optical filter formed from a Mach-Zehnder interferometer with crossed waveguide arms.

### DETAILED DESCRIPTION

All-pass filters are linear systems that have an amplitude response that is constant over all frequencies and a phase response that varies with frequency. FIG. 1 shows a schematic diagram of a generalized APF in its most simple form. The APF 100 includes a 2×2 network 104, which is a device having two input ports 110 and 112 and two output ports 120 and 122. The relationship between the input and output ports are determined by a transfer matrix that specifies the interference that arises among the signals received at the input ports, which in turn determines the signals that will be provided at the output ports. The primary constraint on a network employed in an ideal APF is that its transfer matrix must be unitary, implying that it is a lossless device. In practice, of course, any practical network has losses and thus, strictly speaking, cannot serve as an APF. However, following conventional practice, such devices will nevertheless be referred to as an APF. As seen in FIG. 1, the APF 100 also includes an input waveguide 130 coupled to input port 112 for receiving the signal undergoing dispersion compensation. An output waveguide 134 is coupled to output port 134 for providing the dispersion compensated signal. The APF 100 is completed by connecting output port 120 to input port 110 with a delay line to form a feedback path 108. Instead of a simple delay line, the feedback path may include an optional frequency-dependent element 130. Frequency dependent element 130 must also be an APF. That is, the APF 100 shown in FIG. 1 may be built “recursively” by placing another APF in the feedback path of APF 100.

Examples of 2×2 networks that can be employed in an APF include directional couplers and Mach-Zehnder interferometers, which can both be implemented in planar waveguide technology. FIG. 2 shows an example of an APF in which the 2×2 network 204 is a directional coupler consisting of optical waveguides 210 and 212 in close proximity to one another. As shown, the output port of waveguide 212 is connected to the input port of waveguide 212 by a delay line 214, thus forming a ring resonator APF in which a ring is coupled to a straight waveguide. Likewise, FIG. 3 shows an example of an APF in which the 2×2 network 304 is a Mach-Zehnder interferometer in which the output of one of its two asymmetric arms 310 and 312 is connected to its input by delay line 314. FIG. 9 shows another example of an all-pass optical filter formed from a Mach-Zehnder interferometer in which interferometer structure has crossed waveguide arms of about equal length.

The present invention encompasses other types of networks as well. For example, a Gires-Tournois interferometer may be used. Moreover, the simple APFs depicted in FIGS. 1-3 and 9 may be generalized by employing an N×N network instead of simply a 2×2 network. In this more general case (N−1) of the outputs are respectively coupled to (N−1) of the inputs. Moreover, while FIGS. 1-3 show a single stage APF, APFs more generally may employ multiple stages in which the total length of the feedback path is the sum of the length of the individual feedback paths of each stage. Examples of a multiple stage APF are shown in FIGS. 6A and 6B of U.S. Pat. No. 6,289,151.

In operation, when an optical pulse enters the all-pass optical filter shown in FIG. 2 on the input of waveguide 210, a portion of the optical pulse is optically coupled to the feedback path 214. The portion of the optical pulse provided to the feedback path 214 circulates repeatedly therein. However, at each pass of the optical pulse in the feedback path 214, some portion thereof is coupled back to the output of waveguide 210. Providing some portion of the optical pulse circulating in the feedback path 214 to waveguide 210 incrementally reduces the portion of the optical pulse introduced into the feedback path 214, in effect removing it therefrom. The coupling constant between waveguides 210 and 212 determines the portions of the optical pulse that are coupled into and away from the feedback path 214.

A simple but intuitive understanding of the operation of the APF is as follows. Assuming the length of the feedback path 214 is much shorter (typically about one order of magnitude) than the optical pulse length, the input optical pulse circulates repeatedly along the feedback path 214, thus interfering with itself. That is, the leading edge portions of the optical signal circulating in the feedback path interfere with the trailing edge portions of the optical signal being input thereto. Dispersion compensation arises from the interference between the leading and trailing edges of the optical pulse, which applies a frequency dependent time delay to each frequency contained therein.

A more mathematically rigorous analysis of an APF shows that the transfer function of this simple APF is given by

$$H ( ω ) = \frac{{ⅇ}^{jω T} - R}{r {ⅇ}^{jω T} - 1} \qquad ( 1 )$$

where r is the coupling coefficient between the input and output ports of the APF, and T, the roundtrip time in the ring, is given by

$$T = \frac{L}{{v}_{g}} = \frac{2 π R}{c / {n}_{g}} \qquad ( 2 )$$

where R is the ring radius, c is the speed of light in vacuum, ν_{g} is the group velocity and n_{g} is the group index in the ring.

The phase is obtained from tan⁻¹ [Im{H(ω)}/Re{H(ω)}]:

φ(ω)=2 tan⁻¹ [coth(χ/2) tan (ωT/2)] (3)

where χ is equal to lnr.

It can be shown that the group delay response of this device is given by

$$τ ( ω ) = T \frac{sinh χ}{cosh χ - cos ( ω T )} \qquad ( 4 )$$

where χ is related to the coupling constant. The peak group delay is at ω=0 where

τ(0)=Tcot h(χ/2 (5)

and the minimum delay is at ω=±π/T where

τ(±π/T)=T tan h(χ/2) (6)

From eq. (4) it can be seen that the response is periodic in frequency with a period that is known as the free spectral range (FSR) and is given by ωT=2π. Since ω=2πf, the FSR is simply

FSR=1/T (7)

It should be noted that if the group delay given by eq. (4) is integrated over one FSR the result is 2πT regardless of the value of the coupling χ. This is a demonstration of the bandwidth tradeoff of the device: for a given ring with fixed T, increasing the peak delay requires reducing χ (see eq.(5)), which would mean reducing the bandwidth to keep the “area” under one FSR fixed.

As previously mentioned, the APF shown in U.S. Pat. No. 6,289,151 does not take into account the optical losses that inherently arise in such a device. The following analysis considers a more realistic APF having finite loss (or gain), which can be introduced as an imaginary part of the frequency (ω→ω+jθ).

In this case the round trip loss can be calculated using Γ=exp(−θT). The transfer function is now given by

$$H ( ω ) = \frac{{e}^{j ( ω + j θ ) T} - r}{r {ⅇ}^{j ( ω + jθ ) T} - 1} \qquad ( 8 )$$

In this case the complex phase of the signal is given by

2 tan⁻¹ [coth(χ/2) tan ((ω+iθ)T/2) (9)

We first examine the imaginary part of the phase, which is responsible for the loss/gain, i.e., the amplitude response. It can be shown that the amplitude response (exp[−Imφ) is

$$\sqrt{\frac{cos ( ω T ) - cosh ( χ - ϑ T )}{cos ( ω T ) - cosh ( χ + ϑ T )}} \qquad ( 10 )$$

Note that when the loss goes to zero (∂=0) the above expression is unity, as expected from a lossless APF. We can use the relation ∂T=αL, where α is the loss per roundtrip and L is the ring circumference. We also note that going from loss to gain (∂→−∂) simply inverts the above expression.

It can be shown that the group delay response is now

$$τ ( ω ) = T \frac{[ cosh ( χ ) - cos ( ω T ) cosh ( ϑ T ) ] sinh χ}{[ cos ( ω T ) - cosh ( χ - ϑ T ) ] [ cos ( ω T ) - cosh ( χ + ϑ T ) ]} \qquad ( 11 )$$

again, as we let the loss vanish we recover the lossless APF delay response of eq. (4). Note that here as we go from loss to gain (∂→−∂), the response stays unchanged. It is interesting that by introducing finite loss/gain we can enhance the peak group delay, however in the case of loss we get a big transmission dip and for gain we get amplification.

By considering a practical device in which gain is introduced into the feedback path of the APF, the present inventors have recognized that an APF with enhanced functionality can be achieved. The additional functionality can be employed in a number of different ways, a few of which will be examined in turn below. Following this discussion, some exemplary arrangements for providing gain to an APF will be presented.

In a first example of the enhanced functionality that can be achieved, by supplying variable gain to the APF the value of the dispersion it provides can be tuned. FIG. 4, which arises from the previous mathematical analysis, shows a graph of the group delay (in arbitrary units) of the APF versus wavelength for different values of gain. It can readily be seen that if variable gain is supplied to the feedback path of the APF, a tunable dispersion compensator can be provided. By contrast, in a passive APF without gain control, the dispersion can only be tuned by varying the coupling constant or the roundtrip time in the feedback path. In addition to a change in dispersion with changing gain, the graph also shows that the bandwidth of the device decreases as the dispersion increases.

In a second example of the enhanced functionality that can be achieved, the APF can be used as a variable gain amplifier by tuning either its coupling coefficient or its resonant wavelength. FIG. 5 shows a graph of the amplitude response (in arbitrary units) of the APF with a fixed gain coefficient and different coupling coefficients r of 0.1, 0.5, and 0.7. Clearly, there is trade-off between the dynamic range and the bandwidth, which is similar to that of a conventional APF. A broader bandwidth can be achieved by using a series of APFs that are slightly detuned. One problem with this arrangement is that ring laser oscillations may arise. These oscillations may be avoided by ensuring that the round trip gain does not exceed the coupling coefficient across the whole spectral range of the amplifier emission. However, this may be difficult to achieve if the gain at the signal wavelength is much less than the peak gain at some wavelength within the whole spectral range of the device. Accordingly, some gain equalization may be required. For example, a gain equalizing filter may be incorporated directly into the ring of the APF.

In a third example of the enhanced functionality that can be achieved, the inherent resonant losses that arise in a conventional APF can be compensated for by introducing gain into the feedback path, thus producing an APF with a truly flat amplitude response. Such losses are indicated in FIG. 6, which shows a graph of the amplitude response (in arbitrary units) of a conventional APF for three different coupling coefficients (0.8, 0.6 and 0.4) and for a typical roundtrip loss of 0.7 dB (θ=0.85). A truly flat spectral response can be achieved by supplying gain to feedback path of the APF so that θ=1.

In a fourth example of the enhanced functionality that can be achieved, in addition to resonant losses, all internal losses such as insertion losses and the like which arise in an APF can be compensated for by introducing gain throughout the APF. This is particularly important because practical APF implementations that meet realistic specifications require a structure with a series of coupled ring resonators. As the number of ring resonators in the series increases, the losses increase sharply. By compensating for these losses by adding gain, the number of coupled ring resonators that can be used may be significantly increased.

In accordance with the present invention, gain may be supplied to an APF in a variety of different ways. The particular manner in which the gain is supplied will depend on a number of different factors, including the particular APF configuration that is to be used. For example, in some embodiments of the invention a rare-earth doped optical amplifier may be directly incorporated into the APF. In a rare-earth doped optical amplifier rare-earth ions are used as the active element. The ions are doped in a fiber core in which the signal travels and pumped to provide gain. While many different rare-earth ions can be used to provide gain in different portions of the spectrum, erbium-doped fiber amplifiers (EDFAs) have proven to be particularly attractive because they are operable in the spectral region where optical loss in the fiber is minimal. Accordingly, while the following exemplary embodiments of the invention employ erbium as the active element, those of ordinary skill in the art will recognize that the present invention more generally encompasses any rare-earth ions that can be used in a doped optical amplifier. Of course, other types of optical amplifiers such as an electrically pumped semiconductor (e.g., an InP-based waveguide either hybridly or monolithically integrated) can be used as gain elements.

FIG. 7 shows an APF similar to that shown in FIG. 2, which as previously mentioned employs a directional coupler. In FIG. 7, the fiber constituting feedback path 502 is doped with erbium along its length. In particular, the erbium may be doped along the entire length of the feedback path 502 to form a distributed amplifier or, alternatively, erbium may be doped along only a portion of feedback path 502. A pump source 510 supplies pump power to the feedback path 502 via a coupler 512. The coupler 512 is configured to couple optical energy corresponding to the wavelength of the pump source 510 without coupling optical energy at the signal wavelength. For example, assuming a signal wavelength of 1550 nm and a pump wavelength of 980 nm, coupler 512 is configured to strongly couple optical energy at 980 nm and weakly couple optical energy at 1550 nm. The gain supplied by the optical amplifier formed in feedback path 502 can be adjusted in a conventional manner. For example, if it is desired to maintain the power of the signal traveling in the feedback path 502 at a constant level, the optical amplifier can be operated in saturation.

While the embodiment of the invention shown in FIG. 7 can compensate for resonant losses arising in the feedback path, it does not compensate for all internal losses that can arise in the APF. For instance, gain needs to be supplied to the waveguides 504 through which the optical signal enters and exits the APF in order to compensate for internal losses that arise in the waveguide 504. Once again, this may be achieved by doping waveguide 504 with erbium and supplying pump power thereto. The pump power may be supplied in a number of different ways that depend on the particular network employed in the APF. If the network is a directional coupler in which optical energy at the signal wavelength is strongly coupled but optical energy at the pump wavelength is weakly coupled, a separate pump source can be provided for waveguide 504. This embodiment of the invention is shown in FIG. 8 in which pump source 610 supplies pump energy to feedback path 602 via coupler 612 and pump source 614 supplies pump energy to waveguide 604 via coupler 616. Alternatively, a single pump source can be used to supply pump energy to both the feedback path 602 and the waveguide 604 if the APF can couple both the signal and pump wavelengths between the waveguide 604 and the feedback path 602. This can be most readily accomplished if the network employed in the APF is a Mach-Zehnder interferometer. In yet another alternative, pump power may be supplied to the APF shown in FIG. 9 in a particularly convenient manner because pump power supplied to the input waveguide is able to traverse the entire structure.

Although various embodiments are specifically illustrated and described herein, it will be appreciated that modifications and variations of the present invention are covered by the above teachings and are within the purview of the appended claims without departing from the spirit and intended scope of the invention. For example, in some embodiments of the invention the feedback path may include a cavity with a plurality of reflectors (in which the path length of the feedback path equals twice the length of the cavity) or a photonic band gap (PBG) structure (in which a two-dimensional array of dielectric layers provide a guided feedback path).

1. An optical device comprising:
an N×N network, where N is an integer greater than or equal to 2, said network having N input ports for receiving optical input energy and N output ports for providing optical output energy, wherein the optical output energy at each of the output ports arises from interference among the optical input energy received at the input ports;
(N−1) feedback paths optically coupling (N−1) of the input ports of the N×N network to (N−1) of the output ports of the N×N network;
a first optical waveguide for receiving an input optical signal, said first optical waveguide being coupled to a remaining one of the input ports of the N×N network;
a second optical waveguide for the exit of an output optical signal, said second optical waveguide being coupled to a remaining one of the output ports of the N×N network; and
an active element selectively supplying gain or loss to optical energy in at least one of the feedback paths.

2. The optical device of claim 1 wherein said active element is an optical amplifier that includes a rare-earth active element and a pump source for pumping the rare-earth active element.

3. The optical device of claim 2 wherein said rare-earth active element is doped in said at least one feedback path.

4. The optical device of claim 3 wherein said at least one feedback path includes an optical waveguide and the rare-earth active element extends along substantially the entire length of the optical waveguide.

5. The optical device of claim 1 further comprising a second active element supplying gain or loss in the N×N network.

6. The optical device of claim 1 wherein said active element is configured to substantially compensate for resonant losses that arise in the second optical waveguide.

7. The optical device of claim 1 wherein each of said feedback paths and a portion of the N×N network comprises at least one ring resonator.

8. The optical device of claim 7 wherein each of said feedback paths and a portion of the N×N network comprises a plurality of ring resonators arranged as a ring cascade.

9. The optical device of claim 7 wherein each of said feedback paths and a portion of the N×N network comprises a plurality of ring resonators arranged as a series of coupled rings.

10. The optical device of claim 1 wherein said N×N network is a 2×2 network.

11. The optical device of claim 10 wherein said 2×2 network is a directional coupler.

12. The optical device of claim 10 wherein said 2×2 network is a Mach-Zehnder interferometer.

13. The optical device of claim 1 further comprising an all-pass filter located in at least one of the feedback paths.

14. The optical device of claim 2 wherein said optical amplifier is configured to substantially compensate for resonant losses that arise in at least one of the feedback paths.

15. An optical device comprising:
an N×N network, where N is an integer greater than or equal to 2, said network having N input ports for receiving optical input energy and N output ports for providing optical output energy, wherein the optical output energy at each of the output ports arises from interference among the optical input energy received at the input ports;
(N−1) feedback paths optically coupling (N−1) of the input ports of the N×N network to (N−1) of the output ports of the N×N network;
a first optical waveguide for receiving an input optical signal, said first optical waveguide being coupled to a remaining one of the input ports of the N×N network;
a second optical waveguide for the exit of an output optical signal, said second optical waveguide being coupled to a remaining one of the output ports of the N×N network; and
an active element selectively supplying gain or loss to optical energy in the N×N network.

16. The optical device of claim 15 wherein said active element is an optical amplifier that includes a rare-earth active element and a pump source for pumping the rare-earth active element.

17. The optical device of claim 16 wherein said rare-earth active element is doped in at least one waveguide located in the N×N network.

18. The optical device of claim 15 further comprising a second active element supplying gain or loss in at least one of the feedback paths.

19. The optical device of claim 15 wherein said active element is configured to at least substantially compensate for resonant losses that arise in the (N−1) feedback paths.

20. The optical device of claim 15 wherein each of said feedback paths and a portion of the N×N network comprises at least one ring resonator.

21. The optical device of claim 20 wherein each of said feedback paths and a portion of the N×N network comprises a plurality of ring resonators arranged as a ring cascade.

22. The optical device of claim 20 wherein each of said feedback paths and a portion of the N×N network comprises a plurality of ring resonators arranged as a series of coupled rings.

23. The optical device of claim 15 wherein said N×N network is a 2×2 network.

24. The optical device of claim 23 wherein said 2×2 network is a directional coupler.

25. The optical device of claim 23 wherein said 2×2 network is a Mach-Zehnder interferometer.

26. The optical device of claim 15 further comprising an all-pass filter located in at least one of the feedback paths.

27. A method of reducing the dispersion of an optical signal comprising the steps of:
directing the optical signal to an input waveguide of an optical device, said input waveguide being coupled to a first input port of an N×N network, where N is an integer greater than or equal to 2, said network having N input ports for receiving optical input energy and N output ports for providing optical output energy, wherein the optical output energy at each of the output ports arises from interference among the optical input energy received at the input ports, said optical device further including (N−1) feedback paths optically coupling (N−1) of the input ports of the N×N network to (N−1) of the output ports of the N×N network, a remaining one of the output ports of the N×N network providing a dispersion compensated optical output signal; and
selectively supplying gain or loss to optical energy in at least one of the feedback paths to reduce to a selected value the dispersion of the dispersion compensated optical output signal.

28. The method of claim 27 wherein gain or loss is selectively supplied by an optical amplifier that includes a rare-earth active element and a pump source for pumping the rare-earth active element.

29. The method of claim 28 wherein said rare-earth active element is doped in said at least one feedback path.

30. The method of claim 29 wherein said at least one feedback path includes an optical waveguide and the rare-earth active element extends along substantially the entire length of the optical waveguide.

31. The method of claim 27 further comprising the step of supplying gain or loss in the N×N network.

32. The method of claim 27 wherein said gain at least substantially compensates for resonant losses that arise in said at least one feedback path.

33. The method of claim 27 wherein each of said feedback paths and a portion of the N×N network comprises at least one ring resonator.

34. The method of claim 33 wherein each of said feedback paths and a portion of the N×N network comprises a plurality of ring resonators arranged as a ring cascade.

35. The method of claim 34 wherein each of said feedback paths and a portion of the N×N network comprises a plurality of ring resonators arranged as a series of coupled rings.

36. The method of claim 27 wherein said N×N network is a 2×2 network.

37. The method of claim 36 wherein said 2×2 network is a directional coupler.

38. The method of claim 36 wherein said 2×2 network is a Mach-Zehnder interferometer.

39. The method of claim 27 further comprising an all-pass filter located in at least one of the feedback paths.

40. The method of claim 32 wherein said gain also substantially compensates for non-resonant losses that arise in the N×N network.

41. A method of reducing the dispersion of an optical signal comprising the steps of:
directing the optical signal to an input waveguide of an optical device, said input waveguide being coupled to a first input port of an N×N network, where N is an integer greater than or equal to 2, said network having N input ports for receiving optical input energy and N output ports for providing optical output energy, wherein the optical output energy at each of the output ports arises from interference among the optical input energy received at the input ports, said optical device further including (N−1) feedback paths optically coupling (N−1) of the input ports of the N×N network to (N−1) of the output ports of the N×N network, a remaining one of the output ports of the N×N network providing a dispersion compensated optical output signal; and
selectively supplying gain or loss to optical energy in said N×N network to reduce to a selected value the dispersion of the dispersion compensated optical output signal.

42. The method of claim 41 wherein gain or loss is selectively supplied by an optical amplifier that includes a rare-earth active element and a pump source for pumping the rare-earth active element.

43. The method of claim 42 wherein said rare-earth active element is doped in at least one waveguide located in said N×N network.

44. The method of claim 41 further comprising the step of supplying gain or loss in at least one of the feedback paths.

45. The method of claim 41 wherein said gain at least substantially compensates for resonant losses that arise in at least one of the feedback paths.

46. The method of claim 41 wherein each of said feedback paths and a portion of the N×N network comprises at least one ring resonator.

47. The method of claim 46 wherein each of said feedback paths and a portion of the N×N network comprises a plurality of ring resonators arranged as a ring cascade.

48. The method of claim 46 wherein each of said feedback paths and a portion of the N×N network comprises a plurality of ring resonators arranged as a series of coupled rings.

49. The method of claim 41 wherein said N×N network is a 2×2 network.

50. The method of claim 49 wherein said 2×2 network is a directional coupler.

51. The method of claim 49 wherein said 2×2 network is a Mach-Zehnder interferometer.

52. The method of claim 41 further comprising an all-pass filter located in at least one of the feedback paths.

53. The method of claim 45 wherein said gain also substantially compensates for non-resonant losses that arise in the N×N network.

54. A method of amplifying an optical signal comprising the steps of:
directing the optical signal to an input waveguide of an optical device, said input waveguide being coupled to a first input port of an N×N network, where N is an integer greater than or equal to 2, said network having N input ports for receiving optical input energy and N output ports for providing optical output energy, wherein the optical output energy at each of the output ports arises from interference among the optical input energy received at the input ports, said optical device further including (N−1) feedback paths optically coupling (N−1) of the input ports of the N×N network to (N−1) of the output ports of the N×N network, a remaining one of the output ports of the N×N network providing a optical output signal; and
selectively tuning a coupling coefficient between the first input port and said remaining one of the output ports to adjust to a selected value the gain or loss imparted to the optical output signal.

55. The method of claim 54 wherein each of said feedback paths and a portion of the N×N network comprises at least one ring resonator.

56. The method of claim 54 wherein each of said feedback paths and a portion of the N×N network comprises a plurality of ring resonators arranged as a ring cascade.

57. The method of claim 55 wherein each of said feedback paths and a portion of the N×N network comprises a plurality of ring resonators arranged as a series of coupled rings.

58. The method of claim 54 wherein said N×N network is a 2×2 network.

59. The method of claim 58 wherein said 2×2 network is a directional coupler.

60. The method of claim 58 wherein said 2×2 network is a Mach-Zehnder interferometer.

61. The method of claim 54 further comprising an all-pass filter located in at least one of the feedback paths.

62. A method of amplifying an optical signal comprising the steps of:
directing the optical signal to an input waveguide of an optical device, said input waveguide being coupled to a first input port of an N×N network, where N is an integer greater than or equal to 2, said network having N input ports for receiving optical input energy and N output ports for providing optical output energy, wherein the optical output energy at each of the output ports arises from interference among the optical input energy received at the input ports, said optical device further including (N−1) feedback paths optically coupling (N−1) of the input ports of the N×N network to (N−1) of the output ports of the N×N network, a remaining one of the output ports of the N×N network providing a optical output signal; and
selectively tuning a resonant wavelength in at least one of the feedback paths to adjust to a selected value the gain or loss imparted to the optical output signal.

63. The method of claim 62 wherein each of said feedback paths and a portion of the N×N network comprises at least one ring resonator.

64. The method of claim 62 wherein each of said feedback paths and a portion of the N×N network comprises a plurality of ring resonators arranged as a ring cascade.

65. The method of claim 63 wherein each of said feedback paths and a portion of the N×N network comprises a plurality of ring resonators arranged as a series of coupled rings.

66. The method of claim 62 wherein said N×N network is a 2×2 network.

67. The method of claim 66 wherein said 2×2 network is a directional coupler.

68. The method of claim 66 wherein said 2×2 network is a Mach-Zehnder interferometer.

69. The method of claim 66 further comprising an all-pass filter located in at least one of the feedback paths.

70. The optical device of claim 1 wherein said active element is an optical amplifier that includes an electrically pumped semiconductor waveguide.

71. The optical device of claim 70 wherein said semiconductor waveguide is an InP-based waveguide.

72. The optical device of claim 15 wherein said active element is an optical amplifier that includes an electrically pumped semiconductor waveguide.

73. The optical device of claim 70 wherein said semiconductor waveguide is an InP-based waveguide.

74. The optical device of claim 1 wherein at least one of said feedback paths includes a cavity with a plurality of reflectors.

75. The optical device of claim 1 wherein said at least one feedback path includes a photonic band gap structure.

76. The optical device of claim 75 wherein the photonic band gap structure includes a plurality of a dielectric material for confining optical energy.

77. The optical device of claim 1 wherein said N×N network is a Gires-Tournois interferometer.
